(19) United States
(12) Patent Application Publication
(10) Pub. No.: US 2006/0001349 A1
(43) Pub. Date: Jan. 5, 2006

(54) Electron gun for cathode-ray tube and color cathode-ray tube equipped with the same

(75) Inventor: Tomonari Ishihara, Ibaraki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/169,487

(22) Filed: Jun. 29, 2005

(30) Foreign Application Priority Data
Jun. 30, 2004 (JP) 2004-194122

(51) Int. Cl. H01J 29/50

(52) U.S. Cl. 313/414

(57) ABSTRACT

An electron gun for use in a cathode-ray tube that can reduce a spot dimension of an electron beam when the electron beam is in a high current range and that can suppress moire when the electron beam is in a low current range, and a color cathode-ray tube equipped with the foregoing electron gun, are provided. In the case where a current of the electron beam is in a low current range, a maximum converging effect exerted on an outermost part in the vertical direction of the electron beam, in the vicinity of the third electrode side of electron beam passage apertures, is weaker than a maximum converging effect exerted on an outermost part in the horizontal direction of the electron beam. In the case where a current of the electron beam is in a high current range, in the electron beam passage apertures of the second electrode and in a space between the second electrode and the third electrode, a maximum converging effect exerted on the outermost part in the horizontal direction of the electron beam is substantially equal to a maximum converging effect exerted on the outermost part in the vertical direction of the electron beam.

### BACKGROUND OF THE INVENTION

1. Field of the Invention

The present invention relates to an electron gun for use in a cathode-ray tube, and to a color cathode-ray tube equipped with the same.

2. Description of Related Art

In a TV set in which a color cathode-ray tube is used, video characteristics are required to provide high image quality through the entire brightness range from low brightness to high brightness. In the cathode-ray tube, the brightness control is achieved by adjusting the current of an electron beam incident on a phosphor screen.

However, an increase in the current of the electron beam increases a spot dimension of the electron beam incident on the phosphor screen, thereby decreasing resolution and degrading the image quality. On the other hand, a decrease in the current for the electron beam causes moire (raster moire) to tend to occur, thereby degrading the image quality. It should be noted that “moire” refers to interference fringes arising due to interference between scanning lines of the electron beam and apertures of a shadow mask through which an electron beam passes. The moire occurs more frequently when a dimension of a spot of the electron beam on the phosphor screen decreases excessively (so as to be smaller than a certain size).

A method for suppressing an increase in a spot dimension of an electron beam when a current of the electron beam is in a high current range is disclosed in, for instance, JP-A-59(1984)-148242. The following describes the method. FIG. 13 is a cross-sectional view of a conventional electron gun. In FIG. 13, the x-axis direction is a horizontal direction, the y-axis direction is a vertical direction, and the z-axis direction is a tube axis direction. It should be noted that the respective directions of the x, y, and z axes apply to the drawings other than FIG. 13. As shown in FIG. 13, the electron gun 60 is composed of cathodes 61 for red, green, and blue, a first electrode 62, a second electrode 63, a third electrode 64, and a fourth electrode 65 arranged in the stated order along the z axis direction. The first electrode 62 is grounded, a voltage Vg2 is applied to the second electrode 63, a voltage Vf is applied to the third electrode 64, and a voltage Va is applied to the fourth electrode 65. The cathodes 61, the first electrode 62, and the second electrode 63 constitute an electron beam generating section, while the third electrode 64 and the fourth electrode 65 constitute a main lens section.

FIGS. 14 and 15 are first and second schematic diagrams for illustrating the relationship between respective electrodes of conventional electron guns and an electron beam. Illustrations of the electron gun 60a in FIG. 14 and the electron gun 60b in FIG. 15 are obtained by more schematically illustrating the electron gun 60 shown in FIG. 13, and illustration of a part of the third electrode 64 and the fourth electrode 65 is omitted particularly. Besides, FIGS. 14 and 15 are sectional views of cross sections taken along vertical planes. It should be noted that in FIGS. 14 and 15, among the cathodes 61 for red, green, and blue, one arranged in the center is illustrated as cathode 61, and hence, a central axis 69 indicating a direction in which the electron beam travels falls on the z axis (tube axis).

In the electron guns 60a and 60b shown in FIGS. 14 and 15, the second electrode 63 and the third electrode 64 form a prefocus lens 66. As shown in FIGS. 14 and 15, the prefocus lens 66 is composed of a converging lens 66a and a diverging lens 66b, the former being formed on the second electrode 63 side, the latter being formed on the third electrode 64 side.

The electron gun 60b shown in FIG. 15 has a structure in which the prefocus lens 66 has greater converging and diverging effects as compared with the electron gun 60a shown in FIG. 14. The converging and diverging effects of a prefocus lens can be intensified by, for instance, increasing a difference between a voltage applied to the second electrode 63 and a voltage applied to the third electrode 64.

Therefore, in the electron gun 60b shown in FIG. 15, since it has a structure in which the prefocus lens 66 has greater converging and diverging effects, the high-powered converging lens 66a formed in the vicinity of an electron beam passage aperture 63a of the second electrode 63 and the high-powered diverging lens 66b formed in the vicinity of an electron beam passage aperture 64a of the third electrode 64 are arranged closer to each other.

An electron beam emitted from an electrode beam emitting section (the cathode 61, the first and second electrodes 62 and 63) is affected by the converging and diverging effects of the prefocus lens 66. In the electron gun 60a shown in FIG. 14, since the converging and diverging effects of the prefocus lens 66 are weaker, electron beams 68a and 68b emitted in the vicinity of the center of the cathode 61 and electron beams 67a and 67b emitted from outermost parts of the cathode 61 are less affected by the converging and diverging effects. However, in the electron gun 60b shown in FIG. 15, though electron beams 68a and 68b emitted in the vicinity of the center of the cathode 61 are less affected by the converging and diverging effects, electron beams 67a and 67b emitted from outermost parts of the cathode 61 are affected by strong converging and diverging effects by the prefocus lens 66. Therefore, the spot dimension of the electron beam on a phosphor screen is reduced. Thus, with intensified converging and diverging effects of the prefocus lens 66, the spot dimension of the electron beam is reduced.

Besides the foregoing method, to intensify the converging and diverging effects of the prefocus lens 66, a gap between the second electrode 63 and the third electrode 64 may be narrowed. This intensifies the converging and diverging effects of the prefocus lens 66.

The following describes a method for preventing the occurrence of moire. Moire occurs depending on an interval of scanning lines and an interval of the vertical direction between electron beam passage apertures of a shadow mask. Since a decrease in a dimension of the electron beam at an object focusing point makes the scanning lines thinner, interference between the electron beam and the electron beam passage apertures tends to occur, which causes moire. In other words, the occurrence of moire depends on a spot dimension in the vertical direction (hereinafter referred to as vertical spot dimension) of an electron beam upon its arrival at the phosphor screen. When the vertical spot dimension of the electron beam on the phosphor screen is at a certain level (normally about 0.6 mm) or smaller, a gap is formed between adjacent scanning lines in the vertical direction. This causes interference between the electron beam passage apertures arranged regularly in the shadow mask and the scanning lines, which tends to cause moire. This moire clearly appears when the current of the electron beam is in a low current range of not more than 0.1 mA. This is because a low current causes the dimension in the vertical direction at the object focusing point (the dimension at the virtual object focusing point) to decrease, thereby causing the spot dimension of the electron beam to decrease. Besides, in peripheral parts of the phosphor screen, the vertical spot dimension of the electron beam is smaller as compared with that in the center of the phosphor screen.

FIGS. 16 and 17 are first and second diagrams illustrating the the relationship between a focus voltage and a vertical spot dimension of an electron beam on a phosphor screen in the case where a current of the electron beam is low in a conventional cathode-ray tube. In FIGS. 16 and 17, solid lines indicate the relationship between a focus voltage and a vertical spot dimension of the electron beam in the center of the phosphor screen, while broken lines indicate the relationship between a focus voltage and a vertical spot dimension of the electron beam at peripheral parts of the phosphor screen. FIGS. 16 and 17 both indicate the case where the current of the electron beam is in the low current range.

A magnetic field that causes an electron beam to scan and deflect exerts a converging effect on the electron beam in the direction perpendicular to the traveling direction of the electron beam in the peripheral parts of the phosphor screen. Therefore, there is a tendency that a just focus voltage in the peripheral parts of the phosphor screen is higher than a just focus voltage in the center of the phosphor screen and a spot dimension of the electron beam in a just focus state is smaller in the peripheral parts of the phosphor screen than that in the center of the phosphor screen. Here, the just focus state refers to a state in which the spot dimension of the electron beam is minimum, and the just focus voltage refers to the focus voltage in that state.

A selected range 71 of the focus voltage in a color cathode-ray tube device, shown in FIGS. 16 and 17, is normally set in a range in which the focusing state is best when the current of the electron beam is in a middle and high current range, i.e., 1 mA to 4 mA. Horizontal lines 72 shown in FIGS. 16 and 17 indicate a threshold value of the moire occurrence, and when the vertical spot dimension of the electron beam is below the value indicated by the horizontal line 72, moire tends to occur. In FIG. 16, the value of the vertical spot dimension of the electron beam is below the value indicated by the horizontal line 72 in the selected range 71 of the focus voltage. In other words, in the state of the low current range as shown in FIG. 16, moire occurs.

Therefore, with such settings that vertical spot dimension of the electron beam in the low current range is above the value indicated by the horizontal line 72 in the selected range 71 of the focus voltage as shown in FIG. 17, moire does not occur. This can be achieved by increasing a spot dimension of the electron beam in the low current range and setting the selected range 71 of the focus voltage so that the range is higher than the focus voltage in a high current range. The foregoing characteristics are common in a dynamic-focus-type electron gun that is designed so that deflection aberration is corrected by generating a quadrupole lens with a voltage varying in synchronization with screen scanning, and a non-dynamic-type electron gun in which a focus voltage is fixed.

On the other hand, in a conventional electron gun, in order for a desired electric field distribution to be formed, for instance, the shape of an electron beam passage aperture of each electrode is specified. This is disclosed by, for instance, JP-A-01(1989)-187744, JP-A-08(1996)-106862, and JP-A-2001-332184.

An increase in a power of a prefocus lens for improving a focusing performance in a high current range causes, as described above, a spot dimension of an electric beam to decrease, thereby increasing the resolution, but the spot dimension of the electron beam is decreased excessively in a low current range, and moire occurs. Further, an increase in the power of the prefocus lens causes a virtual object point position to shift to a phosphor screen side, and an amount of the shift is greater in a low current range, whereby a just focus voltage in the low current range is lowered. Consequently, the just focus voltage in the low current range (particularly in the vertical direction) is lower than that in the range normally set for the focus voltage (when the electron beam is in a middle and high current range (1 mA to 4 mA)), which results in the relationship as shown in FIG. 16. In other words, moire tends to occur. However, in the case where the power of the prefocus lens is set to be weak enough that moire does not occur, the relationship shown in FIG. 17 can be realized, whereas a spot dimension of an electron beam in the high current range is increased, which makes it difficult to achieve high image quality (high resolution) as demanded recently.

### SUMMARY OF THE INVENTION

The present invention was made so as to solve the above-described problems of the prior art, and it is an object of the present invention to provide an electron gun for use in a cathode-ray tube that can reduce a spot dimension of an electron beam when the electron beam is in a high current range and that can suppress moire when the electron beam is in a low current range, and a color cathode-ray tube equipped with the foregoing electron gun.

A first electron gun for use in a cathode-ray tube of the present invention is an inline-type electron gun for use in a cathode-ray tube that includes a triode section in which cathodes, a first electrode, and a second electrode are formed in the stated order, and a main lens section including at least a third electrode that accelerates and converges electron beams emitted from the triode section toward a phosphor screen. In the second electrode, electron beam passage apertures are formed. In the case where a current of each electron beam is not more than 0.1 mA, in the vicinity of a third electrode side of the electron beam passage apertures of the second electrode, a maximum converging effect exerted on an outermost part of the electron beam in a direction perpendicular to an inline direction and perpendicular to a traveling direction of the electron beam is weaker than a maximum converging effect exerted on an outermost part in the inline direction of the electron beam. In the case where a current of each electron beam is not less than 2 mA, in the vicinity of the third electrode side of the electron beam passage apertures of the second electrode, the maximum converging effect exerted on the outermost part in the inline direction of the electron beam is substantially equal to the maximum converging effect exerted on the outermost part of the electron beam in the direction perpendicular to the inline direction and perpendicular to the traveling direction of the electron beam. It should be noted that the traveling direction of the electron beams is the same direction as the tube axis direction.

Further, a second electron gun for use in a cathode-ray tube of the present invention is an inline-type electron gun for use in a cathode-ray tube that includes a triode section in which cathodes, a first electrode, and a second electrode are formed in the stated order, and a main lens section including at least a third electrode that accelerates and converges electron beams emitted from the triode section toward a phosphor screen. In the second electrode, electron beam passage apertures are formed.

When the current of each electron beam is not more than 0.1 mA, the following relationship is satisfied:
Ay>0, Ax>0, Ay/Ax<1.0
and when the current of each electron beam is not less than 2 mA, the following relationship is satisfied:
Ay>0, Ax>0, 0.9<Ay/Ax
where Ax is a maximum value of an acceleration component perpendicular to a center axis of each electron beam and directed toward the center axis, in an acceleration in an outermost part in an inline direction of the electron beam, in the vicinity of a third electrode side of the electron beam passage apertures of the second electrode, and Ay is a maximum value of an acceleration component perpendicular to the center axis of the electron beam and directed toward the center axis, in an acceleration in an outermost part of the electron beam in the direction perpendicular to the inline direction and perpendicular to a traveling direction of the electron beam, in the vicinity of the third electrode side of the electron beam passage apertures of the second electrode.

Still further, a color cathode-ray tube of the present invention includes the above-described electron gun of the present invention.

### BRIEF DESCRIPTION OF THE DRAWINGS

FIG. 1 is a cross-sectional view illustrating a color cathode-ray tube in accordance with an embodiment of the present invention in which an electron gun in accordance with the present invention is mounted.

FIG. 2 is a cross-sectional view illustrating a configuration of an electron gun in accordance with an embodiment of the present invention.

FIG. 3 is a front view illustrating a configuration of a first electrode in accordance with the present embodiment.

FIG. 4 is a perspective view illustrating the configuration of the first electrode in accordance with the present embodiment.

FIG. 5 is a front view illustrating a configuration of a second electrode in accordance with the present embodiment.

FIG. 6 is a perspective view illustrating the configuration of the second electrode in accordance with the present embodiment.

FIG. 7 is a front view illustrating a configuration of a third electrode in accordance with the present embodiment.

FIG. 8 is a perspective view illustrating the configuration of the third electrode in accordance with the present embodiment.

FIG. 9 illustrates, regarding the electron gun in accordance with the present embodiment when the current thereof is in the low current range, the relationship between a position in the z-axis direction in the electron gun and an acceleration in an outermost part in the vertical direction of the electron beam, and the relationship between the foregoing position and an acceleration in an outermost part in the horizontal direction of the electron beam.

FIG. 10 illustrates, regarding the electron gun in accordance with the present embodiment when the current thereof is in the high current range, the relationship between a position in the z-axis direction in the electron gun and an acceleration in an outermost part in the vertical direction of the electron beam, and the relationship between the foregoing position and an acceleration in an outermost part in the horizontal direction of the electron beam.

FIG. 11 is a cross-sectional view illustrating a configuration of an electron gun in accordance with the present embodiment that was used in measurement.

FIG. 12 is a cross-sectional view illustrating a configuration of another electron gun in accordance with the present embodiment.

FIG. 13 is a cross-sectional view of a conventional electron gun.

FIG. 14 is a first schematic view illustrating the relationship between electrodes and electron beams of a conventional electron gun.

FIG. 15 is a second schematic view illustrating the relationship between electrodes and electron beams of a conventional electron gun.

FIG. 16 is a first diagram illustrating the relationship between a focus voltage and a vertical dimension of each electron beam on a phosphor screen when a current of the electron beams of a conventional cathode-ray tube is a low current.

FIG. 17 is a second diagram illustrating the relationship between a focus voltage and a vertical dimension of each electron beam on a phosphor screen when a current of the electron beams of a conventional cathode-ray tube is a low current.

### DETAILED DESCRIPTION OF THE INVENTION

The first electron gun for use in a cathode-ray tube of the present invention controls the courses of the electron beams, as described above. Therefore, it can reduce a spot dimension in the case where the electron beams are in a high current range, while it can suppress moire in the case where the electron beams are in a low current range.

Further, the second electron gun for use in a cathode-ray tube of the present invention is configured so that the above-described converging effect is exerted on the electron beams in the vicinity of the third electrode side of the electron beam passage apertures of the second electrode. Therefore, it can reduce a spot dimension in the case where the electron beams are in a high current range, while it can suppress moire in the case where the electron beams are in a low current range.

Still further, the first and second electron guns for use in a cathode-ray tube of the present invention preferably are configured so that: electron beam passage apertures are formed in the first electrode, and each electron beam passage aperture of the first electrode is in an approximately rectangular shape having sides extending in a direction perpendicular to the inline direction and sides extending in a direction parallel with the inline direction; each electron beam passage aperture of the second electrode is in an approximately circular shape; and, on a face of the second electrode on a third electrode side, a recess is formed around each electron beam passage aperture of the second electrode, which recess is a groove in an approximately rectangular shape having sides extending in a direction perpendicular to the inline direction and sides extending in a direction parallel with the inline direction, the side perpendicular to the inline direction being longer than the side parallel with the inline direction. This makes it possible to reduce a spot dimension in the case where the electron beams are in a high current range, and to suppress moire in the case where the electron beams are in a low current range.

Still further, the first and second electron guns for use in a cathode-ray tube of the present invention preferably are configured so that the following expressions are satisfied:
1.0<h₁/v₁<1.5
0.2<g₁₂/r₂<0.4
0.1<(h₂₃−r₂)/t₂₃<5
0.9<g₂₃/r₂<1.8,
where h₁ is a dimension of the electron beam passage aperture of the first electrode in the inline direction, v₁ is a dimension of the electron beam passage aperture of the first electrode in a direction perpendicular to the inline direction, r₂ is a dimension of the electron beam passage aperture of the second electrode, t₂₃ is a depth of the recess of the second electrode, h₂₃ is a dimension of the recess of the second electrode in the inline direction, g₁₂ is a gap between faces of the first electrode and the second electrode that face each other, and g₂₃ is a gap between faces of the second electrode and the third electrode that face each other.

This configuration provides the above-described acceleration to the electron beams, thereby reducing a spot dimension in the case where the electron beams are in a high current range, and suppressing moire in the case where the electron beams are in a low current range.

Still further, the first and second electron guns for use in a cathode-ray tube of the present invention preferably are configured so that, on a face of the first electrode on a second electrode side, a recess is formed around each electron beam passage aperture of the first electrode, which recess is a groove in an approximately rectangular shape having sides extending in a direction perpendicular to the inline direction and sides extending in a direction parallel with the inline direction, the side perpendicular to the inline direction being longer than the side parallel with the inline direction.

This configuration provides the above-described acceleration to the electron beams, thereby reducing a spot dimension in the case where the electron beams are in a high current range, and suppressing moire in the case where the electron beams are in a low current range.

Still further, the first and second electron guns for use in a cathode-ray tube of the present invention preferably are configured so that the following expressions are satisfied:
0.1(mm)<(h₁₂−h₁)(mm)<1.5(mm)
0.1(mm)<(v₁₂−v₁)(mm)<1.5(mm)
where h₁₂ is a dimension of the recess of the first electrode in the inline direction, and v₁₂ is a dimension of the recess of the first electrode in the direction perpendicular to the inline direction.

This configuration provides the above-described acceleration to the electron beams, thereby reducing a spot dimension in the case where the electron beams are in a high current range, and suppressing moire in the case where the electron beams are in a low current range.

Still further, the first and second electron guns for use in a cathode-ray tube of the present invention preferably are configured so that: electron beam passage apertures, each of which is in an approximately circular shape, are formed in the third electrode; on a face of the third electrode on a second electrode side, a recess is formed around each electron beam passage aperture of the third electrode, which recess is a groove in an approximately rectangular shape having sides extending in a direction perpendicular to the inline direction and sides extending in a direction parallel with the inline direction, the side perpendicular to the inline direction being longer than the side parallel with the inline direction; and the following expressions are satisfied:
1.0<r₃/r₂<2.0
(h₃₂−r₃)/t₃₂<4.0
where r₃ is an aperture dimension of the electron beam passage aperture of the third electrode, t₃₂ is a depth of the recess of the third electrode, h₃₂ is a dimension of the recess of the third electrode in the inline direction.

This configuration reduces a spot dimension in the case where the electron beams are in a high current range, and suppresses moire in the case where the electron beams are in a low current range.

Besides, the color cathode-ray tube of the present invention provides high image quality since it is equipped with an electron gun for use in a cathode-ray tube of the present invention.

Hereinafter, the present invention will be described by way of an illustrative embodiment with reference to the drawings.

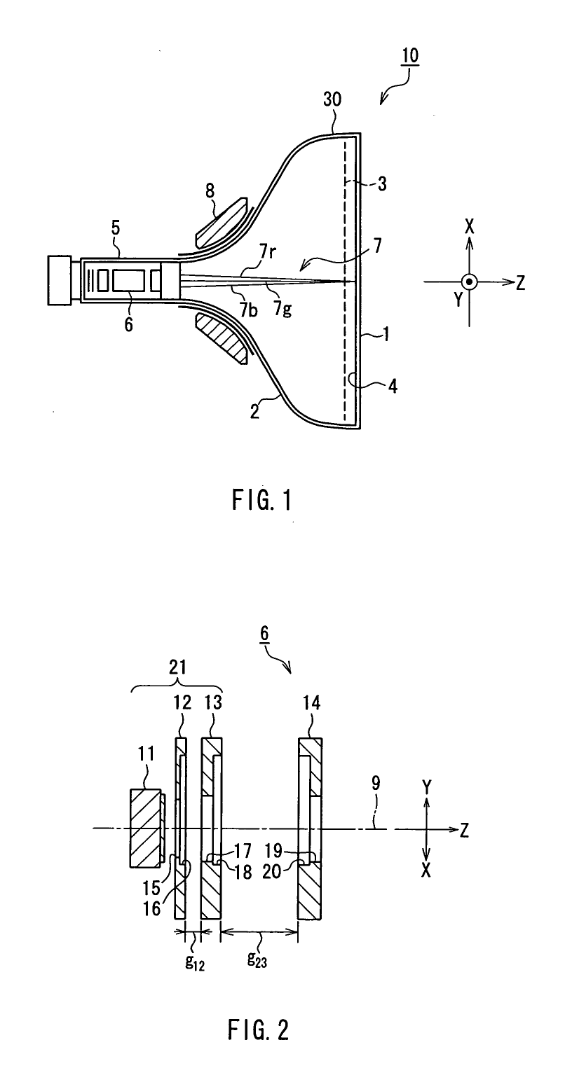

The following will describe an electron gun for use in a cathode-ray tube and a color cathode-ray tube equipped with the foregoing electron gun in accordance with an embodiment of the present invention by referring to the drawings. FIG. 1 is a cross-sectional view of a color cathode-ray tube in accordance with the present embodiment in which an electron gun for use in a cathode-ray tube in accordance with the present invention is mounted. It should be noted that in FIG. 1, the x-axis direction is a horizontal direction, the y-axis direction is a vertical direction, and the z-axis direction is a tube axis direction. A cathode-ray tube 10 shown in FIG. 1 is a self-convergence inline-type color cathode ray tube. As shown in FIG. 1, the cathode-ray tube 10 includes an envelope 30 composed of a panel 1, a neck 5, and a funnel 2 that is bonded integrally to the panel 1 and the neck 5. On an inside face of the panel 1, a phosphor screen 4 is arranged, which is composed of three-color phosphor layers in a stripe form or a dot form that emit blue, green, and red color lights. A shadow mask 3 has a multiplicity of electron beam passage apertures therein, and is arranged in the envelope 30 so as to face the phosphor screen 4. In the neck 5, an inline-type electron gun (structure) 6, which is an electron gun for use in the cathode-ray tube, is positioned. The electron gun 6 emits an electron beam 7. The electron beam 7 includes a center beam 7g and a pair of side beams 7b and 7r, which are arranged in one line on one horizontal plane. A deflection yoke 8 is arranged on a perimeter of a part ranging from a large-dimension-part of the funnel 2 to the neck 5.

The deflection yoke 8 generates a non-uniform deflection magnetic field for deflecting the electron beam 7 emitted from the electron gun 6 in the horizontal direction (x-axis direction) and the vertical direction (y-axis direction). The non-uniform deflection magnetic field is formed by a pincushion-type horizontal deflection magnetic field and a barrel-type vertical deflection magnetic field. The electron beam 7 emitted from the electron gun 6 is deflected by the non-uniform deflection magnetic field generated by the deflection yoke 8, and scans the phosphor screen 4 in the horizontal direction and the vertical direction via the shadow mask 3. With this, a color image is displayed on the panel 1.

By referring to FIG. 2 additionally, the following describes the electron gun 6 in accordance with the present embodiment. FIG. 2 is a cross-sectional view illustrating a structure of the electron gun in accordance with the embodiment of the present invention. It should be noted that in FIG. 2, the x-axis direction is a horizontal direction, the y-axis direction is a vertical direction, and the z-axis direction is a tube axis direction. In other words, FIG. 2 illustrates a vertical cross-sectional view below the z axis, and a horizontal cross-sectional view above the z axis. Further, among the three cathodes 11 arranged linearly, FIG. 2 shows only one cathode 11 arranged in the center. A center axis 9 indicating a direction in which the electron beam travels falls on the z axis (tube axis).

The electron gun 6 of the present embodiment is an electron gun in which three electron beams are aligned in an inline form, and as shown in FIG. 2, the cathode 11, a first electrode 12, a second electrode 13, and a third electrode 14 are arranged in the stated order in the z-axis direction. It should be noted that, though not shown, the cathodes 11 for red, green, and blue colors are aligned in the horizontal direction (inline direction). The cathodes 11, the first electrode 12, and the second electrode 13 constitute a triode section 21. Further, the third electrode 14 is a part of a main lens section.

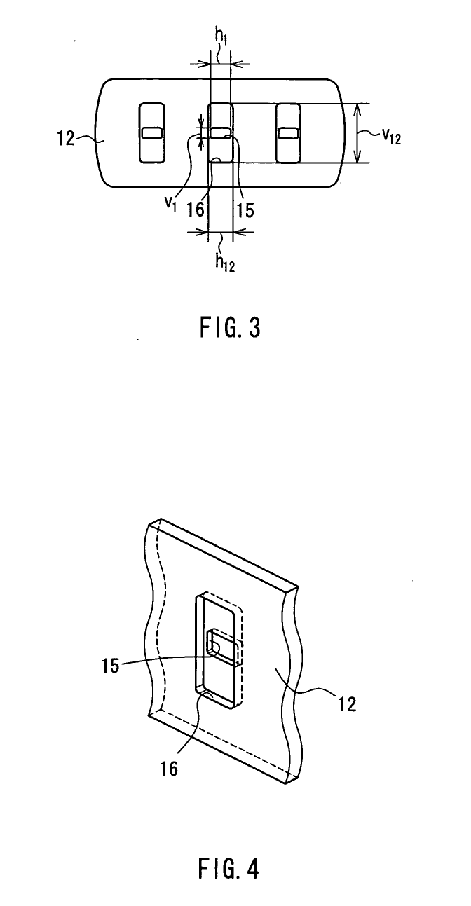

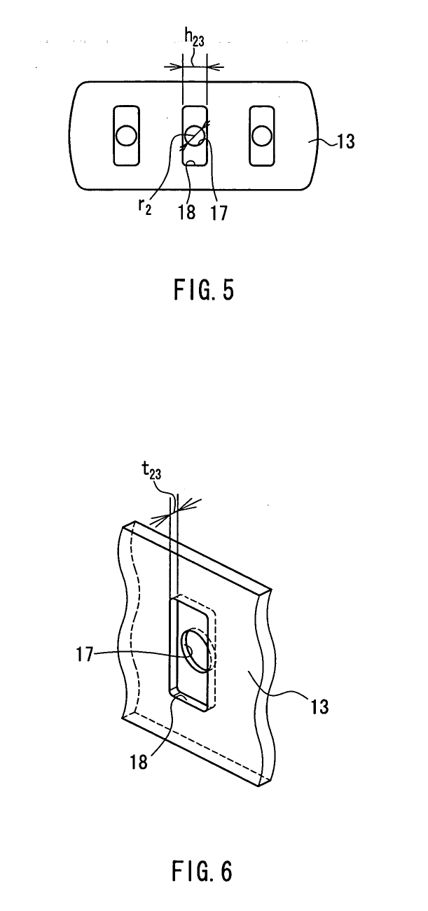

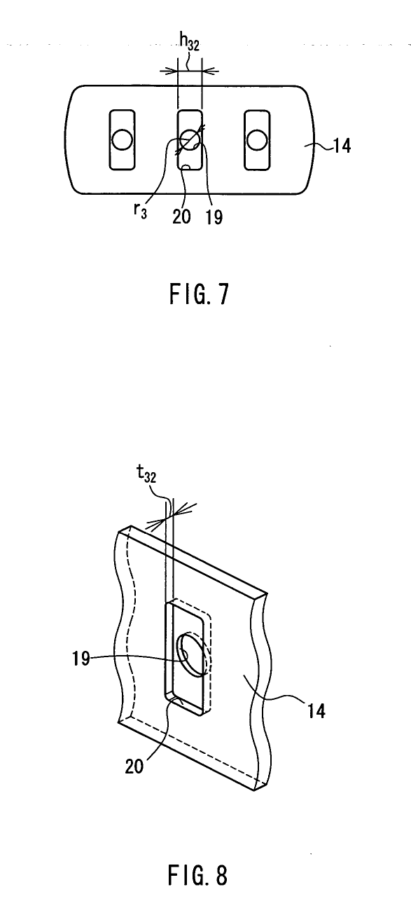

Further, by referring to FIGS. 3 to 8 additionally, the first electrode 12, the second electrode 13, and the third electrode 14 are described. FIG. 3 is a front view illustrating a configuration of the first electrode 12, and FIG. 4 is a perspective view illustrating a configuration of the first electrode 12. FIG. 5 is a front view illustrating a configuration of the second electrode 13, and FIG. 6 is a perspective view illustrating a configuration of the second electrode 13. FIG. 7 is a front view illustrating a configuration of the third electrode 14, and FIG. 8 is a perspective view illustrating a configuration of the third electrode 14. It should be noted that FIGS. 4, 6, and 8 illustrate only vicinities of electron beam passage apertures in the center of the first, second, and third electrodes 12, 13, and 14, respectively.

As shown in FIGS. 3 and 4, the first electrode 12 has three electron beam passage apertures 15 arranged in the inline direction, each of which is in a substantially rectangular shape that is longer in the horizontal direction than in the vertical direction. It should be noted that desirably each side of the electron beam passage aperture 15 is perfectly linear. Each corner of the electron beam passage aperture 15 may be a sharp corner with a right angle, but alternatively it may be rounded as shown in FIGS. 3 and 4. Further alternatively, each corner may be shaped with a part of a polygon. On a face of the first electrode 12 on the second electrode 13 side, recesses 16 are formed around the electron beam passage apertures 15, respectively. Each recess 16 is a groove in a substantially rectangular shape that has sides extending in the horizontal direction and sides extending in the vertical direction, the side extending in the vertical direction being longer than that in the horizontal direction. It should be noted that desirably each longer side of the recess 16 is perfectly linear, while each shorter side thereof does not have to be perfectly linear. Further, each corner of the recess 16 may be a sharp corner with a right angle, but alternatively it may be rounded as shown in FIGS. 3 and 4. Further alternatively, each corner may be shaped with a part of a polygon.

Further, as shown in FIGS. 5 and 6, the second electrode 13 has three electron beam passage apertures 17 aligned in the inline direction, each of which is in a substantially circular shape. On a face of the second electrode 13 on the third electrode 14 side, recesses 18 are formed around the electron beam passage apertures 17, respectively. Each recess 18 is a groove in a substantially rectangular shape that has sides extending in the horizontal direction and sides extending in the vertical direction, the side extending in the vertical direction being longer than that in the horizontal direction. It should be noted that desirably each longer side of the recess 18 is perfectly linear, while each shorter side thereof does not have to be perfectly linear. Further, each corner of the recess 18 may be a sharp corner with a right angle, but alternatively it may be rounded as shown in FIGS. 5 and 6. Further alternatively, each corner may be shaped with a part of a polygon.

As shown in FIGS. 7 and 8, the third electrode 14 has three electron beam passage apertures 19 aligned in the inline direction, each of which is in a substantially circular shape. On a face of the third electrode 14 on the second electrode 13 side, recesses 20 are formed around the electron beam passage apertures 19, respectively. Each recess 20 is a groove in a substantially rectangular shape that has sides extending in the horizontal direction and sides extending in the vertical direction, the side extending in the vertical direction being longer than that in the horizontal direction. It should be noted that desirably each longer side of the recess 20 is perfectly linear, while each shorter side thereof does not have to be perfectly linear. Further, each corner of the recess 20 may be a sharp corner with a right angle, but alternatively it may be rounded as shown in FIGS. 7 and 8. Further alternatively, each corner may be shaped with a part of a polygon.

In the electron gun 6 of the foregoing configuration, in the case where the current of each electron beam 7 (7r, 7g, 7b) emitted by the triode section 21 is not more than 0.1 mA (in a low current range), in the vicinity of the third electrode 14 side of the electron beam passage aperture 17 of the second electrode 13 (in the vicinity of the recess 18), the maximum converging effect exerted on an outermost part of the electron beam in a direction perpendicular to the inline direction and perpendicular to the electron beam 7 traveling direction (center axis 9 direction), that is, an outermost part in the y-axis direction, is substantially weaker than the maximum converging effect exerted on an outermost part of the electron beam in the inline direction, that is, an outermost part in the x-axis direction.

Further, in the electron gun 6, in the case where the current of each electron beam 7 emitted by the triode section 21 is not less than 2 mA (in a high current range), in the vicinity of the third electrode 14 side of the electron beam passage aperture 17 of the second electrode 13 (in the vicinity of the recess 18), the maximum converging effect exerted on the outermost part of each electron beam 7 in the inline direction, that is, the outermost part in the x-axis direction, is substantially equal to the maximum converging effect exerted on the outermost part of each electron beam 7 in the direction perpendicular to the inline direction and perpendicular to the traveling direction of each electron beam 7 (center axis 9 direction), that is, the outermost part in the y-axis direction. Preferably, a quotient of a value of the maximum converging effect exerted on the outermost part in the x-axis direction of each electron beam 7, divided by a value of the maximum converging effect exerted on the outermost part in the y-axis direction of each electron beam 7, is more than 0.9 and less than 1.1.

Further, the vicinity of the third electrode 14 side of the electron beam passage aperture 17 of the second electrode 13 (the vicinity of the recess 18) refers to an area through which the electron beam 7 can pass, in a space in the electron beam passage aperture 17 and between the second electrode 13 and the third electrode 14.

With this configuration, in the case where each electron beam 7 is in the low current range, the converging effect in the y-axis direction is relatively weak as compared with the converging effect in the x-axis direction in the vicinity of the third electrode 14 side of the electron beam passage aperture 17. Therefore, the convergence of the electron beam 7 in the x-axis direction is greater than the convergence of the electron beams 7 in the y-axis direction. With this, the vertical dimension of a spot of the electron beam 7 on the phosphor screen 4 does not decrease excessively, whereby moire does not occur in the cathode-ray tube 10. Further, in the case where each electron beam 7 is in a high current range, the converging effect in the y-axis direction and the converging effect in the x-axis direction are substantially equal to each other in the vicinity of the third electrode 14 side of the electron beam passage aperture 17. Therefore, the spot dimension of the electron beam 7 on the phosphor screen 4 does not increase excessively, so that the resolution of the cathode-ray tube 10 is not degraded. Consequently, the cathode-ray tube 10 in which the electron gun 6 of the present embodiment is mounted provides high-quality images.

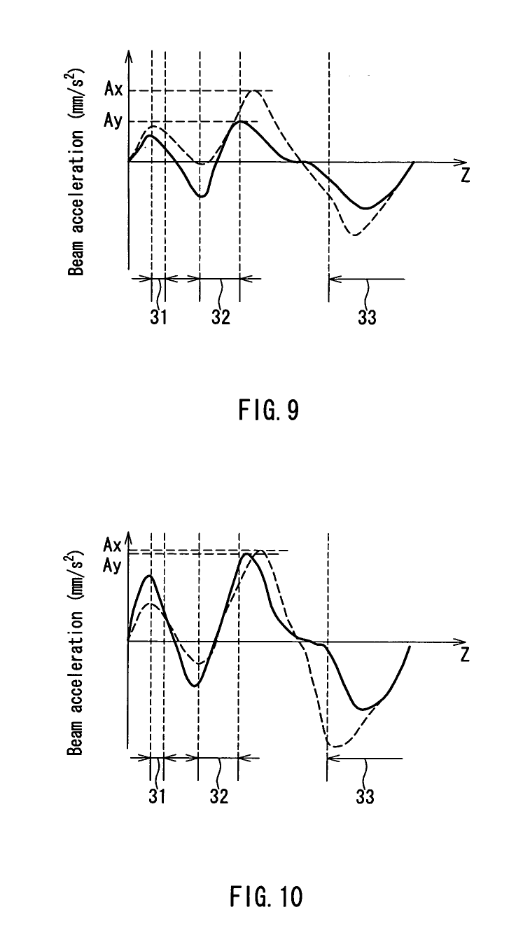

Next, using an acceleration in the direction toward the center axis 9 in the outermost part of the electron beam 7, the following describes conditions for realizing the foregoing converging effect of the electron beam 7 in the low current range and the high current range. FIG. 9 illustrates, regarding the electron gun in accordance with the present embodiment when the current thereof is in the low current range, the relationship between a position in the z-axis direction in the electron gun and an acceleration in an outermost part in the vertical direction (y-axis direction) of the electron beam 7, and the relationship between the foregoing position and an acceleration in an outermost part in the horizontal direction (x-axis direction) of the electron beam 7. FIG. 10 illustrates, regarding the electron gun in accordance with the present embodiment when the current thereof is in the high current range, the relationship between a position in the z-axis direction in the electron gun and an acceleration in an outermost part in the vertical direction (y-axis direction) of the electron beam 7, and the relationship between the foregoing position and an acceleration in an outermost part in the horizontal direction (x-axis direction) of the electron beam 7. The solid lines in FIGS. 9 and 10 indicate accelerations in the outermost part in the vertical direction, and the broken lines indicate accelerations in the outermost part in the horizontal direction. Further, in FIGS. 9 and 10, a range 31 indicates an area where the first electrode 12 is provided, a range 32 indicates an area where the second electrode 13 is provided, and a range 33 indicates an area where the third electrode 14 is provided (see FIG. 2).

In FIGS. 9 and 10, an acceleration in the direction toward the center axis 9 in the horizontal direction or the vertical direction is regarded as positive acceleration. In the vicinity of the recess 18 on the third electrode 14 side around the electron beam passage aperture 17 of the second electrode 13, in an acceleration in the outermost part of the electron beam 7 in the direction perpendicular to the inline direction, that is, the x-axis direction and perpendicular to the electron beam traveling direction (z-axis direction), in other words, the outermost part in the y-axis direction, the acceleration component perpendicular to the center axis 9 and directed toward the center axis 9 has a maximum value. Let this maximum value of the foregoing acceleration component be “acceleration Ay”.

Further, in the vicinity of the recess 18 on the third electrode 14 side around the electron beam passage aperture 17 of the second electrode 13, in an acceleration in the outermost part of the electron beam 7 in the inline direction, that is, the outermost part in the x-axis direction, the acceleration component perpendicular to the center axis 9 and directed toward the center axis 9 has a maximum value. Let this maximum value of the foregoing acceleration component be “acceleration Ax”. Here, as shown in FIGS. 9 and 10, the following relationship preferably is satisfied.

When the current of the electron beam 7 is in the low current range of not more than about 0.1 mA (FIG. 9), the following relationship is satisfied:
Ay>0, Ax>0, Ay/Ax<1.0

When the current of the electron beam 7 is in the high current range of not less than about 2 mA (FIG. 10), the following relationship is satisfied:
Ay>0, Ax>0, 0.9<Ay/Ax
In the case where these relationships are satisfied, when the current of the electron beam 7 is not more than 0.1 mA (in the low current range), in the vicinity of the third electrode 14 side of the electron beam passage aperture 17 of the second electrode 13, the converging effect exerted on an outermost part of the electron beam in a direction perpendicular to the inline direction and perpendicular to the electron beam 7 traveling direction, that is, an outermost part in the y-axis direction, is substantially weaker than the converging effect exerted on an outermost part of the electron beam in the inline direction, that is, an outermost part in the x-axis direction. Further, in the electron gun 6, when the current of each electron beam 7 is not less than 2 mA (in a high current range), in the vicinity of the third electrode 14 side of the electron beam passage aperture 17 of the second electrode 13, the converging effect exerted on the outermost part of each electron beam 7 in the inline direction, that is, the outermost part in the x-axis direction, is substantially equal to the converging effect exerted on the outermost part of each electron beam 7 in the direction perpendicular to the inline direction and perpendicular to the electron beam 7 traveling direction, that is, the outermost part in the y-axis direction.

This makes it possible to reduce the spot dimension the electron beam in the high current range, and efficiently achieve the suppression of moire in the low current range. Consequently, with the cathode-ray tube 10 of the present embodiment in which the electron gun 6 of the present embodiment is mounted, high image quality and high resolution can be achieved in images ranging from low brightness images to high brightness images.

The following describes configurations of respective members of the electron gun 6 of the present embodiment, and preferable values of dimensions of the foregoing members. With such a configuration, the above-described accelerations shown in FIGS. 9 and 10 can be achieved. Here, as shown in FIGS. 2 to 8, let the dimension in the horizontal direction of the electron beam passage aperture 15 of the first electrode 12 be h₁, and let the dimension thereof in the vertical direction be v₁. Let the dimension of the electron beam passage aperture 17 of the second electrode 13 be r₂, let the depth of the recess 18 of the second electrode 13 be t₂₃, and let the dimension of the recess 18 in the horizontal direction be h₂₃. Further, let the dimension of the recess 20 in the third electrode 14 in the horizontal direction be h₃₂, let the depth of the recess 20 be t₃₂, and let the dimension of the electron beam passage aperture 19 of the third electrode be r₃. Still further, let the gap between faces of the first electrode 12 and the second electrode 13 that face each other be g₁₂, and let the gap between faces of the second electrode 13 and the third electrode 14 that face each other be g₂₃.

As described above, by forming the electron beam passage aperture 15 of the first electrode 12 in the rectangular shape that is longer in the horizontal direction than in the vertical direction, a crossover in the vertical direction in the low current range can be formed on the cathode 11 side with respect to the position of a crossover in the horizontal direction. It should be noted that if the spot dimension is decreased in the high current range, the method of forming the electron beam passage aperture 15 of the first electrode 12 in the rectangular form longer in the horizontal direction than in the vertical direction, as described above, is not sufficient to control the electron beam in a manner such that the electron beam is affected by a converging effect that is weaker in the vertical direction than in the horizontal direction in the vicinity of the third electrode 14 side of the electron beam passage aperture 17 of the second electrode 13 in the low current range. Then, as described above, it is preferable to form the recesses 18 around the electron beam passage apertures 17 on the face of the second electrode 13 on the third electrode 14 side, each recess 18 being a rectangular groove that is longer in the vertical direction than in the horizontal direction. With this configuration, in the case where each electron beam 7 is in the low current range, the converging effect in the vertical direction is relatively weak as compared with the converging effect in the horizontal direction, in the vicinity of the third electrode 14 side of the electron beam passage aperture 17 of the second electrode 13. Besides, in the case of the high current range, since the crossover position shifts on the third electrode 14 side as compared with the case in the low current range, the electron beams are less influenced by the recesses 18. In other words, the converging effect in the vertical direction and the converging effect in the horizontal direction are substantially equal to each other in the vicinity of the third electrode 14 side of the electron beam passage aperture 17.

Further, in the case where the above-described effect caused by the recesses 18 is excessively strong, a diverging angle in the vertical direction of the electron beam 7 in the high current range is increased excessively, whereby, affected significantly by deflection aberration, the focus in the vicinity of the phosphor screen 4 is degraded. Further, in the low current range, the electron beam 7 is, either hardly affected by the converging effect in the vicinity of the third electrode 14 side of the second electrode 13, or affected by a diverging effect in the vertical direction. In other words, the acceleration Ay satisfies Ay≈0 or Ay<0. As a result, the virtual object point position shifts to the phosphor screen 4 side, and the dimension at the virtual object point decreases, thereby resulting in moire tending to occur. Further, in the case where the above-described effect caused by the recesses 18 is excessively weak, the decrease of the spot dimension of the electron beam 7 in the high current range and the suppression of moire in the low current range cannot be achieved.

When (h₂₃−r₂)/t₂₃<0.1, the aforementioned effect caused by the recesses 18 is excessively strong, whereas when (h₂₃−r₂)/t₂₃>5, the effect caused by the recesses 18 is excessively weak. In other words, by satisfying the condition of 0.1<(h₂₃−r₂)/t₂₃<5, a preferable effect can be obtained.

Thus, by satisfying the following conditions, the above-described relationship of the acceleration Ax and the acceleration Ay is satisfied.
1.0<h₁/v₁<1.5
0.1<(h₂₃−r₂)/t₂₃<5
Further, it is more preferable that the following inequalities should be satisfied:
0.2<g₁₂/r₂<0.4
0.9<g₂₃/r₂<1.8

By setting the dimensions of the members used, the above-described relationship of the acceleration Ax and the acceleration Ay is established in the electron gun 6. In other words, when the current of the electron beam 7 is in the low current range, the following relationship is established:
Ay>0, Ax>0, Ay/Ax<1.0
When the current of the electron beam 7 is in the high current range, the following relationship is established:
Ay>0, Ax>0, 0.9<Ay/Ax

Further, in addition to the above-described conditional expressions being satisfied, which expressions are:
1.0<h₁/v₁<1.5
0.2<g₁₂/r₂<0.4
0.1<(h₂₃−r₂)/t₂₃<5
0.9<g₂₃/r₂<1.8,
it is preferable that the electron beam passage apertures 19, each of which is in a substantially circular shape, are formed in the third electrode 14, and the recesses 20 are formed around the electron beam passage apertures 19 on a face of the third electrode 14 on the second electrode 13 side, each recess 20 being in a substantially rectangular shape that has sides extending in the horizontal direction and sides extending in the vertical direction, the side in the vertical direction being longer than that in the horizontal direction. Further, the dimensions preferably satisfy the following conditions:
1.0<r₃/r₂<2.0
(h₃₂−r₃)/t₃₂<4.0

By so doing, the spot dimension of the electron beam in the high current range can be reduced, while moire can be suppressed efficiently when the current of the electron beam is in the low current range. Accordingly, with the cathode-ray tube 10 of the present embodiment in which the electron gun 6 of the present embodiment is mounted, high image quality and high resolution can be achieved in images ranging from low brightness images to high brightness images.

Further, in addition to each of the electron beam passage apertures 15 of the first electrode 12 having the rectangular shape that is longer in the horizontal direction than in the vertical direction, it is preferable that the recesses 16 are formed around the electron beam passage apertures 15, respectively, on a face of the first electrode 12 on the second electrode 13 side. Each recess 16 is a groove in a substantially rectangular shape that is longer in the vertical direction than in the horizontal direction. This configuration makes it possible to adjust a crossover position of the electron beam 7 appropriately. Letting a dimension of the recess 16 in the horizontal direction be h₁₂, and letting a dimension thereof in the vertical direction be v₁₂, it is preferable that these dimensions satisfy the following conditions:
0.1(mm)<(h₁₂−h₁)(mm)<1.5(mm)
0.1(mm)<(v₁₂−v₁)(mm)<1.5(mm)

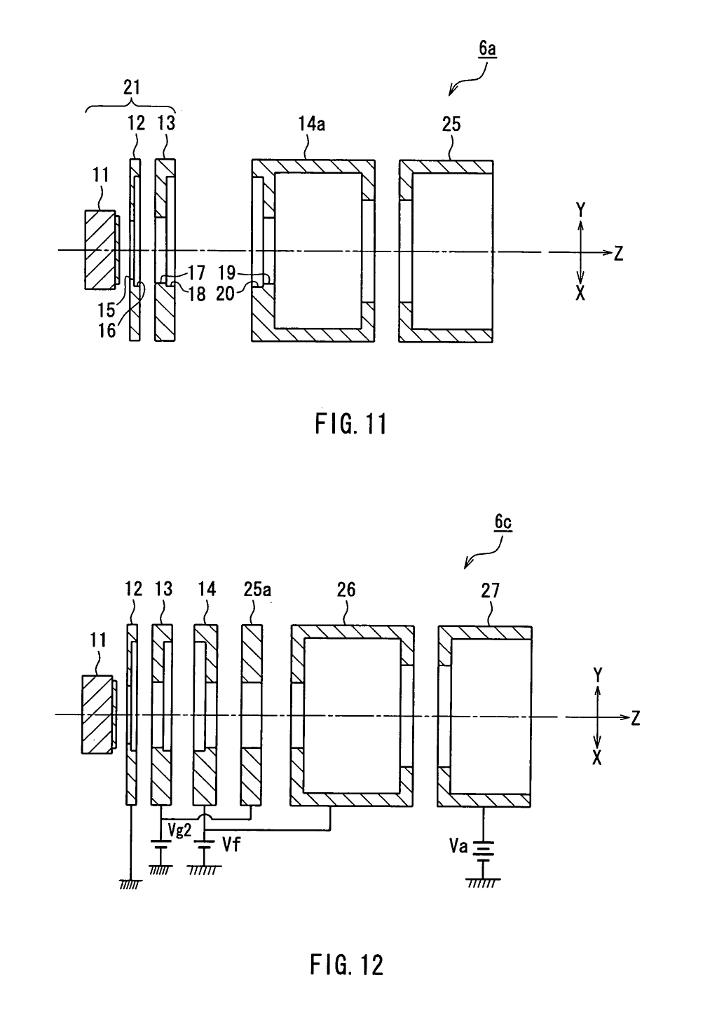

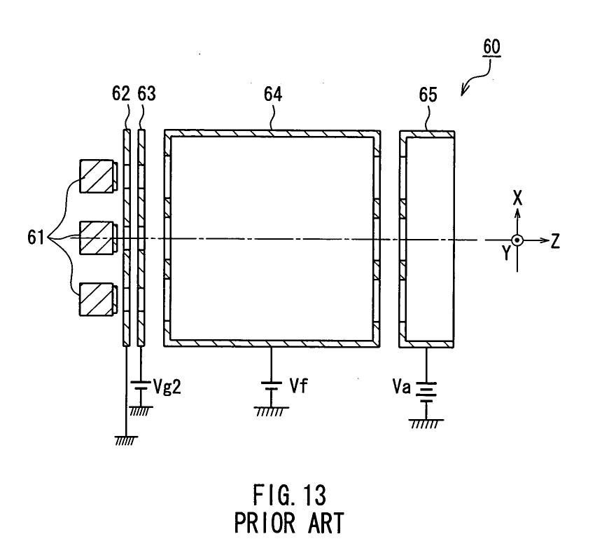

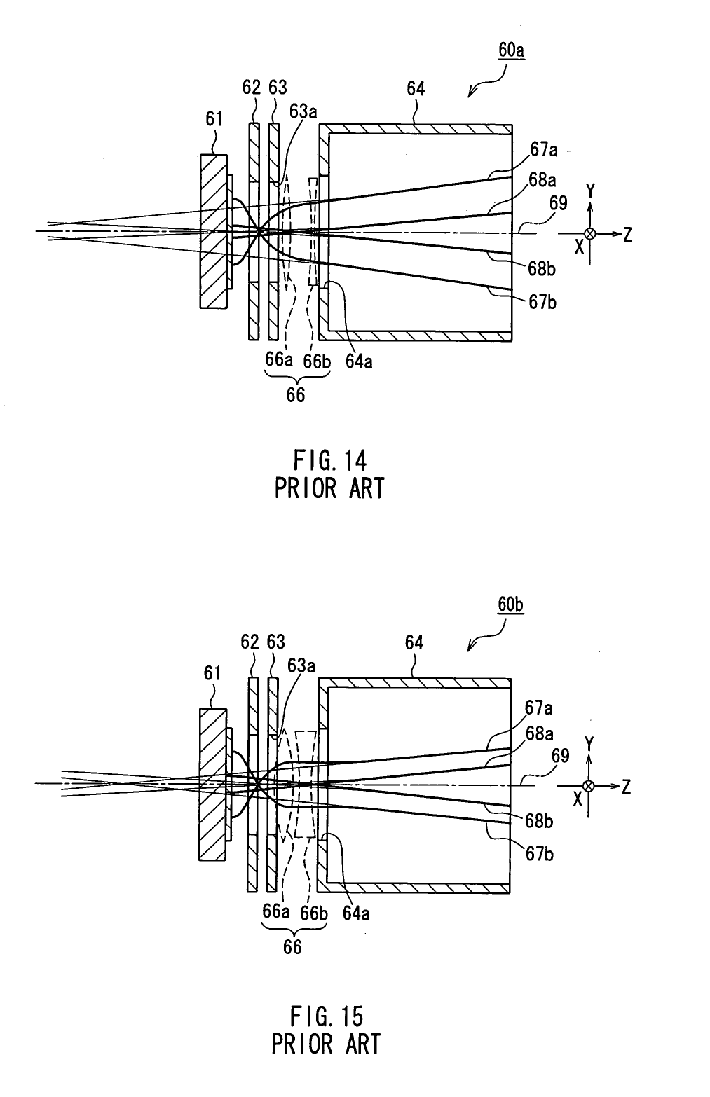

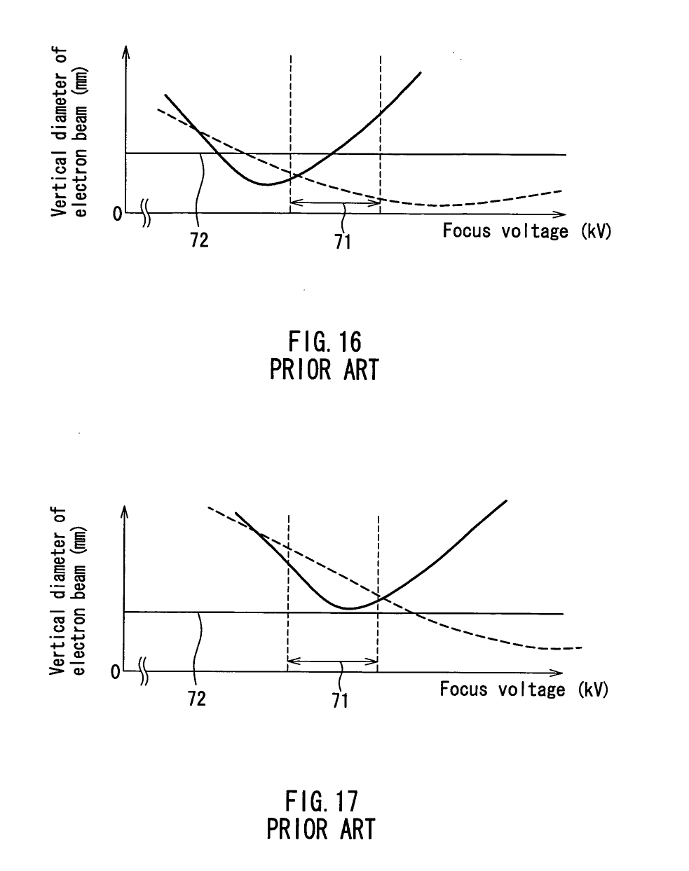

An electron gun of the present embodiment was designed so as to have the above-described configuration, and characteristics thereof were derived by simulation. For the simulation, software for analysis of electric fields and charged particles (for instance, “SCALA” available from Vector Fields Ltd.) may be used. With this, the electric field effect of the electron gun, that is, the acceleration of electrons, can be derived by computation by the infinite element method, the surface charge method, or the like. It should be noted that in the simulation, analysis was made regarding electrons whose acceleration toward the inside in the vertical and horizontal directions of the electron beam is maximum, that is, regarding electrons in the outermost part. FIG. 11 is a cross-sectional view illustrating a configuration of an electron gun 6a in accordance with the present embodiment used in the simulation. As shown in FIG. 11, the third electrode 14a was not in a plate form, and a fourth electrode 25 was provided additionally. The configuration other than these was the same as that of the electron gun 6 shown in FIG. 2.

The dimensions of the members were specified as follows:
h₁/v₁≈1.2
g₁₂/r₂≈0.33
(h₂₃−r₂)/t₂₃≈2.5
g₂₃/r₂≈1.42
r₃/r₂≈1.27
(h₃₂−r₃)/t₃₂≈0.2

The foregoing dimensions satisfy the above-described relationship of the dimensions of the members.

The voltage of the cathode 11 was set in a range from about 10 V to 250 V. It should be noted that the current of the electron beam 7 increases as the cathode voltage decreases. A voltage of about 0 V was applied to the first electrode 12, a voltage of about 300 V to 1000 V was applied to the second electrode 13, a voltage of about 20 kV to 35 kV was applied to the fourth electrode 25, and a voltage of about 20% to 30% of that applied to the fourth electrode 25 was applied to the third electrode 14a. The voltage applied to the third electrode 14a was set so that the electron beam 7 on the phosphor screen 4 exhibited the best focusing state when the current of the electron beam 7 leaving the cathode 11 was about 1 mA to 4 mA.

In this electron gun 6a, a converging effect on the third electrode 14a side of the electron beam passage aperture 15 of the second electrode 13 was strong in the horizontal direction and weak in the vertical direction. Therefore, the electron beam 7, between the second electrode 13 and the third electrode 14a, had a dimension in the horizontal direction longer than that in the vertical direction. Further, since the recess 20 of the third electrode 14a was longer in the vertical direction than in the horizontal direction, the electron beam 7 had a dimension in the horizontal direction longer than that in the vertical direction, whereby the deflection aberration by the deflection yoke 8 applied on the electron beam 7 in the vertical direction was reduced.

The cathode-ray tube in which the electron gun 6a configured as above is mounted makes it possible to suppress moire in the low current range and to reduce a dimension of a spot of the electron beam 7 in the high current range.

In the above-described electron gun 6a, the main lens section is a bipotential-type cylindrical lens composed of the third electrode 14a and the fourth electrode 25, but it may be, for instance, an asymmetric main lens whose electrode apertures are asymmetric, or a superposition-type main lens having an electrode through which all the three electron beams pass commonly. For instance, the configuration may be as that of an electron gun 6c shown in FIG. 12. FIG. 12 is a cross-sectional view illustrating a configuration of another electron gun in accordance with the present embodiment. The configuration of the electron gun 6c shown in FIG. 12 is the same as that of the electron gun 6 shown in FIG. 2 regarding the cathode 11, the first electrode 12, the second electrode 13, and the third electrode 14. The configuration further includes, in the z-axis direction from the third electrode 14, a fourth electrode 25a, a fifth electrode 26, and a sixth electrode 27. Further, the first electrode 12 is grounded, a voltage Vg2 is applied to both the second electrode 13 and the fourth electrode 25, a voltage Vf is applied to both the third electrode 14 and the fifth electrode 26, and a voltage Va is applied to the sixth electrode 27. More specifically, the electron gun 6c has a configuration in which a preliminary converging lens is provided between the prefocus lens and the main lens. A main lens composed of a plurality of electrodes may be used in combination. By setting the dimensions of the members in the above-described ranges, the same effects can be achieved. Further, as shown in FIG. 2, the recesses 20 of the third electrode 14 are provided on the second electrode 13 side thereof, but in the case where the third electrode 14 is in a plate form and a preliminary converging lens is provided as in the electron gun shown in FIG. 12, the same effect can be achieved, for instance, if the recesses 20 are formed on the fourth electrode 25a side.

It should be noted that the above-described specific examples of the embodiment are mere examples, and the present invention is not limited to the above-described configurations and the like.

What is claimed is:

1. An inline-type electron gun for use in a cathode-ray tube, the electron gun comprising:
a triode section in which cathodes, a first electrode, and a second electrode are formed in the stated order; and
a main lens section comprising at least a third electrode, the main lens section accelerating and converging electron beams emitted from the triode section toward a phosphor screen,
wherein
electron beam passage apertures are formed in the second electrode,
in the case where a current of each electron beam is not more than 0.1 mA, in the vicinity of a third electrode side of the electron beam passage apertures of the second electrode, a maximum converging effect exerted on an outermost part of the electron beam in a direction perpendicular to an inline direction and perpendicular to a traveling direction of the electron beam is weaker than a maximum converging effect exerted on an outermost part in the inline direction of the electron beam, and
in the case where a current of each electron beam is not less than 2 mA, in the vicinity of the third electrode side of the electron beam passage apertures of the second electrode, the maximum converging effect exerted on the outermost part in the inline direction of the electron beam is substantially equal to the maximum converging effect exerted on the outermost part of the electron beam in the direction perpendicular to the inline direction and perpendicular to the traveling direction of the electron beam.

2. An inline-type electron gun for use in a cathode-ray tube, the electron gun comprising:
a triode section in which cathodes, a first electrode, and a second electrode are formed in the stated order; and
a main lens section including at least a third electrode, the main lens section accelerating and converging electron beams emitted from the triode section toward a phosphor screen,
wherein
electron beam passage apertures are formed in the second electrode,
when a current of each electron beam is not more than 0.1 mA, the following relationship is satisfied:
Ay>0, Ax>0, Ay/Ax<1.0
and when the current of each electron beam is not less than 2 mA, the following relationship is satisfied:
Ay>0, Ax>0, 0.9<Ay/Ax
where
Ax is a maximum value of an acceleration component perpendicular to a center axis of each electron beam and directed toward the center axis, in an acceleration in an outermost part in an inline direction of the electron beam, in the vicinity of a third electrode side of the electron beam passage apertures of the second electrode, and
Ay is a maximum value of an acceleration component perpendicular to the center axis of the electron beam and directed toward the center axis, in an acceleration in an outermost part of the electron beam in the direction perpendicular to the inline direction and perpendicular to a traveling direction of the electron beam, in the vicinity of the third electrode side of the electron beam passage apertures of the second electrode.

3. The electron gun according to claim 1, wherein
electron beam passage apertures are formed in the first electrode, each electron beam passage aperture of the first electrode being in an approximately rectangular shape having sides extending in a direction perpendicular to the inline direction and sides extending in a direction parallel with the inline direction,
each electron beam passage aperture of the second electrode is in an approximately circular shape, and
on a face of the second electrode on a third electrode side, a recess is formed around each electron beam passage aperture of the second electrode, the recess being a groove in an approximately rectangular shape having sides extending in a direction perpendicular to the inline direction and sides extending in a direction parallel with the inline direction, the side perpendicular to the inline direction being longer than the side parallel with the inline direction.

4. The electron gun according to claim 2, wherein
electron beam passage apertures are formed in the first electrode, each electron beam passage aperture of the first electrode being in an approximately rectangular shape having sides extending in a direction perpendicular to the inline direction and sides extending in a direction parallel with the inline direction,
each electron beam passage aperture of the second electrode is in an approximately circular shape, and
on a face of the second electrode on a third electrode side, a recess is formed around each electron beam passage aperture of the second electrode, the recess being a groove in an approximately rectangular shape having sides extending in a direction perpendicular to the inline direction and sides extending in a direction parallel with the inline direction, the side perpendicular to the inline direction being longer than the side parallel with the inline direction.

5. The electron gun according to claim 3, wherein
the following expressions are satisfied:
1.0<h₁/v₁<1.5
0.2<g₁₂/r₂<0.4
0.1<(h₂₃−r₂)/t₂₃<5
0.9<g₂₃/r₂<1.8,
where
h₁ is a dimension of the electron beam passage aperture of the first electrode in the inline direction,
v₁ is a dimension of the electron beam passage aperture of the first electrode in a direction perpendicular to the inline direction,
r₂ is a dimension of the electron beam passage aperture of the second electrode,
t₂₃ is a depth of the recess of the second electrode,
h₂₃ is a dimension of the recess of the second electrode in the inline direction,
g₁₂ is a gap between faces of the first electrode and the second electrode that face each other, and
g₂₃ is a gap between faces of the second electrode and the third electrode that face each other.

6. The electron gun according to claim 4, wherein
the following expressions are satisfied:
1.0<h₁/v₁<1.5
0.2<g₁₂/r₂<0.4
0.1<(h₂₃−r₂)/t₂₃<5
0.9<g₂₃/r₂<1.8,
where
h₁ is a dimension of the electron beam passage aperture of the first electrode in the inline direction,
v₁ is a dimension of the electron beam passage aperture of the first electrode in a direction perpendicular to the inline direction,
r₂ is a dimension of the electron beam passage aperture of the second electrode,
t₂₃ is a depth of the recess of the second electrode,
h₂₃ is a dimension of the recess of the second electrode in the inline direction,
g₁₂ is a gap between faces of the first electrode and the second electrode that face each other, and
g₂₃ is a gap between faces of the second electrode and the third electrode that face each other.

7. The electron gun according to claim 5, wherein
on a face of the first electrode on a second electrode side, a recess is formed around each electron beam passage aperture of the first electrode, the recess being a groove in an approximately rectangular shape having sides extending in a direction perpendicular to the inline direction and sides extending in a direction parallel with the inline direction, the side perpendicular to the inline direction being longer than the side parallel with the inline direction.

8. The electron gun according to claim 6, wherein
on a face of the first electrode on a second electrode side, a recess is formed around each electron beam passage aperture of the first electrode, the recess being a groove in an approximately rectangular shape having sides extending in a direction perpendicular to the inline direction and sides extending in a direction parallel with the inline direction, the side perpendicular to the inline direction being longer than the side parallel with the inline direction.

9. The electron gun according to claim 7, wherein
the following expressions are satisfied:
0.1(mm)<(h₁₂−h₁)(mm)<1.5(mm)
0.1(mm)<(v₁₂−v₁)(mm)<1.5(mm)
where
h₁₂ is a dimension of the recess of the first electrode in the inline direction, and
v₁₂ is a dimension of the recess of the first electrode in the direction perpendicular to the inline direction.

10. The electron gun according to claim 8, wherein
the following expressions are satisfied:
0.1(mm)<(h₁₂−h₁)(mm)<1.5(mm)
0.1(mm)<(v₁₂−v₁)(mm)<1.5(mm)
where
h₁₂ is a dimension of the recess of the first electrode in the inline direction, and
v₁₂ is a dimension of the recess of the first electrode in the direction perpendicular to the inline direction.

11. The electron gun according to claim 5, wherein
electron beam passage apertures, each being in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

12. The electron gun according to claim 6, wherein
electron beam passage apertures, each in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

13. The electron gun according to claim 7, wherein
electron beam passage apertures, each being in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

14. The electron gun according to claim 8, wherein
electron beam passage apertures, each being in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

15. The electron gun according to claim 9, wherein
electron beam passage apertures, each being in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

16. The electron gun according to claim 10, wherein
electron beam passage apertures, each being in an approximately circular shape, are formed in the third electrode,
on a face of the third electrode on a second electrode side, a recess is formed around each electron beam passage aperture of the third electrode, the recess being a groove in an approximately rectangular shape having sides extending in a direction perpendicular to the inline direction and sides extending in a direction parallel with the inline direction, the side perpendicular to the inline direction being longer than the side parallel with the inline direction, and
the following expressions are satisfied:
1.0<r₃/r₂<2.0
(h₃₂−r₃)/t₃₂<4.0
where
r₃ is an aperture dimension of the electron beam passage aperture of the third electrode,
t₃₂ is a depth of the recess of the third electrode,
h₃₂ is a dimension of the recess of the third electrode in the inline direction.

17. A color cathode-ray tube equipped with the electron gun according to claim 1.

18. A color cathode-ray tube equipped with the electron gun according to claim 2.
